(19) United States
(12) Patent Application Publication
(10) Pub. No.: US 2019/0349676 A1
(43) Pub. Date: Nov. 14, 2019

(54) STREAM SYNCHRONIZATION

(71) Applicant: KNOWLES ELECTRONICS, LLC, Itasca, IL (US)

(72) Inventors: Xiaojun Chen, Itasca, IL (US); Dave Rossum, Mountain View, CA (US)

(73) Assignee: KNOWLES ELECTRONICS, LLC, Itasca, IL (US)

(21) Appl. No.: 16/344,793

(22) PCT Filed: Nov. 7, 2017
(86) PCT No.: PCT/US17/60372

§ 371 Date: Apr. 24, 2019

Related U.S. Application Data
(60) Provisional application No. 62/419,334, filed on Nov. 8, 2016.

(51) Int. Cl. H04R 3/00

(52) U.S. Cl. CPC H04R 3/005; H04R 2410/05; H04S 2420/01; H04S 2400/15

(57) ABSTRACT

Methods and systems for synchronizing audio streams. The method includes tagging a first presentation time to a frame buffer of a first audio stream and a second presentation time to a frame buffer of a second audio stream. The second audio stream is to be synchronized to the first audio stream. The method also includes aligning the second presentation time of the frame buffer of the second audio stream with the first presentation time of the frame buffer of the first audio stream, resampling the second audio stream so that each resampling point of the second stream is aligned with a corresponding sampling point in the first audio stream, and determining sample data for each resampling point of the second audio stream.

### CROSS-REFERENCE TO RELATED APPLICATIONS

This application claims the benefit of and priority to U.S. Provisional Application No. 62/419,334, filed Nov. 8, 2016, the entire contents of which is incorporated herein by reference.

### BACKGROUND

The following description is provided to assist the understanding of the reader. None of the information provided or references cited is admitted to be prior art.

In various applications, two digital audio data streams arriving via different paths are combined to provide a combined audio data signal. Synchronization of the two streams can significantly improve the performance of noise suppression, echo cancellation, etc., on the combined signal. Synchronization refers to the process of compensating the time difference between the two streams so that the two streams are aligned temporally. Improvements on the accuracy of synchronization are generally desired.

### SUMMARY

In general, one aspect of the subject matter described in this specification can be embodied in a method for synchronizing audio streams. The method includes tagging, by a processor, a first presentation time to a frame buffer of a first audio stream and a second presentation time to a frame buffer of a second audio stream. The second audio stream is to be synchronized to the first audio stream. The method also includes aligning the second presentation time of the frame buffer of the second audio stream with the first presentation time of the frame buffer of the first audio stream, resampling the second audio stream so that each resampling point of the second stream is aligned with a corresponding sampling point in the first audio stream, and determining sample data for each resampling point of the second audio stream.

Another aspect of the subject matter can be embodied in an apparatus for synchronizing audio streams. The apparatus includes an audio fabric structured to transport a first audio stream and a second audio stream, and a single sample processor (SSP) communicably connected to the audio fabric. The SSP is structured to tag a first presentation time to a frame buffer of the first audio stream and a second presentation time to a frame buffer of the second audio stream. The second audio stream is to be synchronized to the first audio stream. The SSP is also structured to align the second presentation time of the frame buffer of the second audio stream with the first presentation time of the frame buffer of the first audio stream, resample the second audio stream so that each resampling point of the second audio stream is aligned with a corresponding sampling point in the first audio stream, and determine sample data for each resampling point of the second audio stream.

Yet another aspect of the subject matter can be embodied in a smart microphone. The smart microphone comprises a processor for synchronizing a first audio stream generated by the smart microphone and a second audio stream received from a second microphone. The processor is structured to tag a first presentation time to a frame buffer of the first audio stream and a second presentation time to a frame buffer of the second audio stream. The second audio stream is to be synchronized to the first audio stream. The processor is also structured to align the second presentation time of the frame buffer of the second audio stream with the first presentation time of the frame buffer of the first audio stream, resample the second audio stream so that each resampling point of the second audio stream is aligned with a corresponding sampling point in the first audio stream, and determine sample data for each resampling point of the second audio stream.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1(a) is a schematic diagram of a system for synchronizing two receiving audio streams in accordance with various implementations.

FIG. 1(b) is a schematic diagram of a system for synchronizing two transmitting audio streams in accordance with various implementations.

FIG. 1(c) is a schematic diagram of system for synchronizing a receiving audio stream and a transmitting audio stream in accordance with various implementations.

FIG. 2 is a schematic diagram of a sequence of updating presentation times for frame buffers in accordance with various implementations.

FIG. 3(a) is a schematic diagram showing alignment of two frame buffers of different audio streams in accordance with an implementation.

FIG. 3(b) is a schematic diagram showing alignment of two frame buffers of different audio streams in accordance with another implementation.

FIG. 4(a) is a schematic diagram showing two frames of different audio streams before a fine adjustment in accordance with various implementations.

FIG. 4(b) is a schematic diagram showing the frames of different audio streams before and after the fine adjustment in accordance with various implementations.

FIG. 5 is a flow diagram of a process for synchronizing two audio streams in accordance various implementations.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

### DETAILED DESCRIPTION

The present specification relates generally to audio signal processing and more specifically to audio stream synchronization.

Synchronization of two audio streams with high accuracy can improve the performance of noise suppression and echo cancellation on the combined audio signal. A buffer prefill mechanism can synchronize the streams with a +/− one (1) sample accuracy. The disclosure herein provides a system and method for synchronizing two audio streams with milli-sample accuracy through frame buffer position alignment and resampling. Referring to the figures generally, frame buffers of two audio streams, e.g., a master stream and a slave stream, are tagged with presentation times (i.e., presentation timestamps). A coarse adjustment is performed in which the initial frame position of the slave stream is slid to align with the initial frame position of the master streams within a margin of +/− one sample. Then a fine adjustment is performed in which the slave stream is resampled so that every resampling point of the slave stream is aligned with a corresponding sampling point in the master stream. Accordingly, synchronization accuracy can achieve a milli-sample accuracy level.

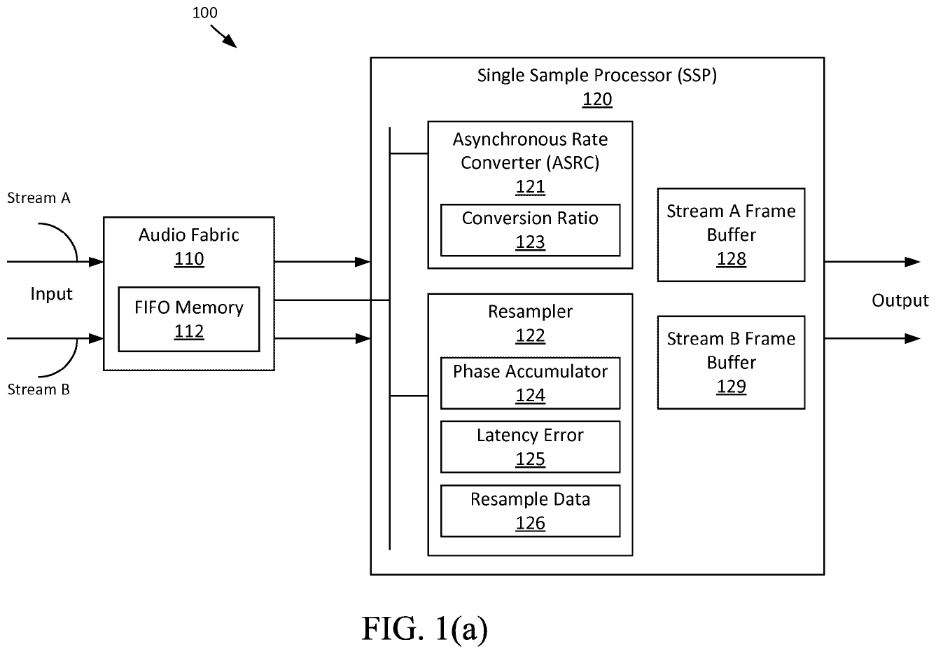

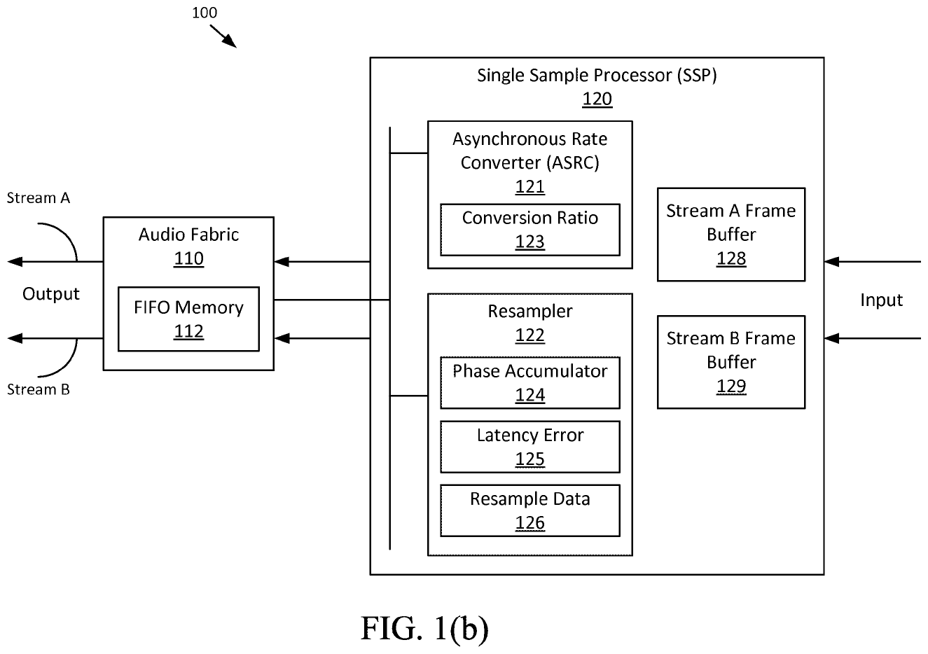

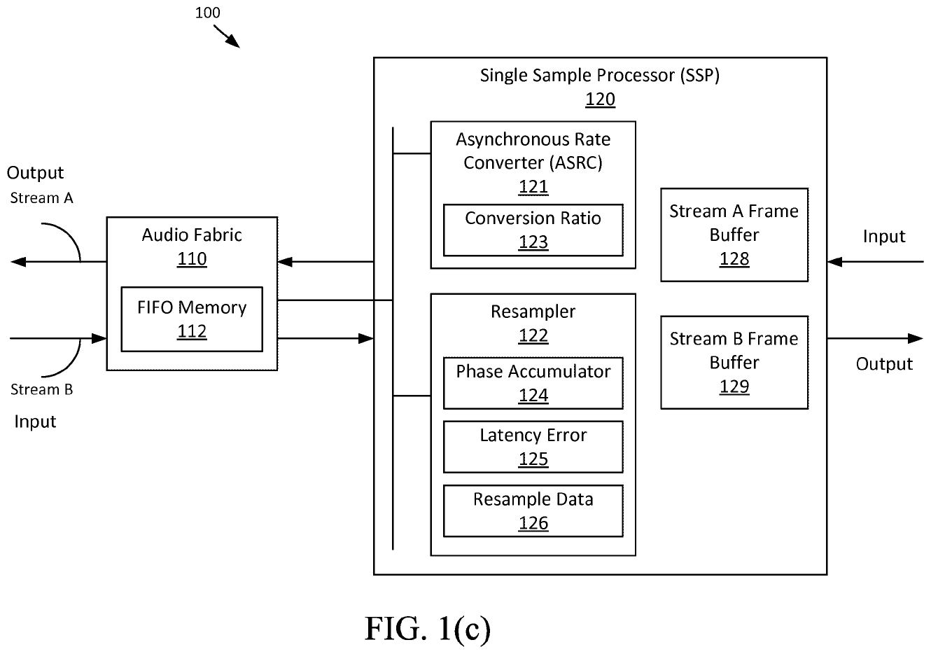

Referring now to FIG. 1(a), a schematic diagram of a system 100 for synchronizing two receiving audio streams, i.e., a master stream A and a slave stream B, is shown in accordance with various implementations. The system 100 may be implemented on an electronic device, such as a smartphone, a tablet, a computer, a workstation, and so on. The system 100 includes an audio fabric 110 and a single sample processor (SSP) 120 communicably connected to the audio fabric 110. The audio fabric 110 can transport the two streams A and B. The SSP 120 may stamp the streams A and B with presentation times counted by a global wall clock and synchronize the streams based on the presentation timestamps. The system 100 can be used for synchronizing two transmitting audio streams, as shown in FIG. 1(b), or for synchronizing one receiving audio stream and one transmitting stream, as shown in FIG. 1(c). As used herein, a receiving audio stream refers to an audio stream from a receive side (e.g., a receiver of a cell phone); a transmitting audio stream refers to an audio stream from a transmit side (e.g., a transmitter of a cell phone). The systems and methods described herein can be applied to the scenarios of synchronizing two receiving audio streams, two transmitting audio streams, and one receiving audio stream and one transmitting audio stream. Unless otherwise specified, the scenario of two receiving audio streams is used as an example for the explanation below.

The two streams A and B may arrive at the audio fabric 110 through different paths from different audio sources (e.g., port). In some embodiments, the system 100 is implemented on a smart microphone. The stream A is generated by the smart microphone and the stream B is received from an external microphone. In some embodiments, the SSP 120 is implemented on the smart microphone and the audio fabric 110 is implemented on a host device (e.g., a host processor) for the smart microphone. The audio fabric 110 can transport various formats of audio streams, such as pulse-code modulation (PCM), pulse-density modulation (PDM), serial low-power inter-chip media bus (SLIMbus), etc. For example, the audio fabric 110 may include a PDM interface for receiving the audio stream generated by a digital microphone, may include a PCM interface for receiving the audio stream generated by an analog microphone and processed by an analog to digital converter (ADC), and so on.

Each of the streams A and B, when arriving at the audio fabric 110, is a digital audio signal and thus consists of a plurality of ordered samples. Streams A and B may have different sample rates in different clock domains. As used herein, the sample rate refers to the number of samples of audio carried per second, measured in Hz or kHz. For example, the sample rate can be 48,000 samples per second (i.e., 48 KHz) for a high fidelity audio, and 8,000 samples per second (i.e., 8 KHz) for a telephone quality audio. The sample rate of streams A and/or B may change over time. As used herein, the clock domain refers to a system operating according to a clock speed. Crystal oscillators, for example, can be used for clocking audio data, which may have some error or drift that causes differences in clock speeds. The system 100 can convert the master stream A from the port into a stream A frame buffer 128 and the slave stream B into a stream B frame buffer 129 with a predetermined algorithm processing sample rate so that the output for the stream A and the output for the stream B have the same sample rate and are on the same clock domain, as will be described in detail below.

The audio fabric 110 creates timestamps to label the time when individual samples arrive at the audio fabric 110. This measurement of the arrival time of samples is called timestamping. The timestamps can be created at a lower rate than the sample rate. For example, timestamps can be created every four samples, every eight samples, every sixteen samples, and so on. The definition of the arrival time of a sample may vary with types of the audio fabric 110 and sometimes with transport parameters. For example, for a sample of a stream in the I²S audio format, the specific instant of “arrival time” may correspond to the instant of the frame sync leading edge for the sample, the instant of the next frame sync leading edge, or sometime in the middle of the sample's arrival. In some embodiments, a global high-speed counter (e.g., a “wall clock”) is used to create the timestamps to label the individual samples. Thus, the arrival time of the sample is measured in the unit of “wall clock periods” of the global counter. At the instant a sample is received, the value of the global counter is read and stored along with the incoming sample. In some embodiments, the global counter has a clock resolution of 24.576 MHz and the timestamps have a precision of 64-bit. Each of the streams A and B is associated with a set of timestamps.

In some embodiments, an audio signal is processed based on frames. As used herein, a frame refers to a set of samples that are processed as a unit. A frame may include various numbers of samples, depending on the sample rate and the frame rate. As used herein, the frame rate refers to the number of frames presented per second (fps). Samples per frame=sample rate/frame rate. For an audio signal with a sample rate of 48 KHz and a frame rate of 24 fps, every frame has 2000 sample (48 KHz/24 fps). Generally, the fewer samples a frame includes, the lower the latency would be, but the more the processing overhead would be. For the frame-based processing to work properly, a buffer can be used to store the frame being processed and a deadline for processing the frame can be set. In particular, the stream A frame buffer 128 is used to store frames for the stream A, and the stream B frame buffer 129 is used to store frames for the stream B. On the receive side, the frame buffer data is referred to as the output of the converted stream data. On the transmit side, the frame buffer data is referred to as the input of the stream data to be converted.

The audio fabric 110 can transport the streams A and B to the single sample processor (SSP) 120 for processing. The SSP 120 is driven by audio fabric sample events. Each of the streams A and B can come from either a receive side or a transmit side. For a stream (e.g., stream A or B) from the receive side, the audio fabric 110 can push an arrived sample into a first in first out (FIFO) memory 112 (e.g., a 2-depth FIFO memory). The audio fabric 110 may also specify a deadline by which the arrived sample must be processed and triggers the SSP 120 to process. The SSP 120 reads a sample from the FIFO memory 112 based on the queue ordered according to the deadline. The samples have been tagged with the presentation time every predefined number of samples (e.g., one in every four samples, one in every eight samples, etc.). The SSP 120 performs a process of rate tracking on the samples that are tagged with the presentation times, which tracks the sample rate of the stream. Details of rate tracking will be discussed in detail below with reference to the asynchronous sample rate converter (ASRC) 121. The SSP 120 may process the samples to generate an output and write the output into a frame buffer (e.g., stream A frame buffer 128 or stream B frame buffer 129). If the frame buffer pointer crosses the boundary of a frame, the SSP 120 can send a frame interrupt.

In some embodiments, the presentation time associated with a sample from the receive side is the wall-clock arrival time of its previous sample. With this offset, the acquisition of a presentation time can cross several clock domain boundaries, and yet the time can be available for the SSP 120 as early as a few clock ticks after the arrival time.

For a stream (e.g., stream A or B) from the transmit side, the audio fabric 110 pops a sample from the memory 112 (e.g., a 2-depth FIFO memory). The audio fabric 110 may also specify a deadline by which the transmit sample must be processed and trigger the SSP 120 to process. The SSP 120 consumes the samples from the frame buffer (e.g., the stream A frame buffer 128 or the stream B frame buffer 129) based on the queue ordered according to the deadline. The samples have been tagged with the presentation time every predefined number of samples (e.g., one in every four samples, one in every eight samples, etc.). The SSP 120 performs a rate tracking process on the sample samples that are tagged with the presentation times. The SSP 120 may process the samples to generate an output and write the output into the FIFO memory 112 for transmitting. If the frame buffer pointer crosses the boundary of a frame, the SSP 120 can send a frame interrupt.

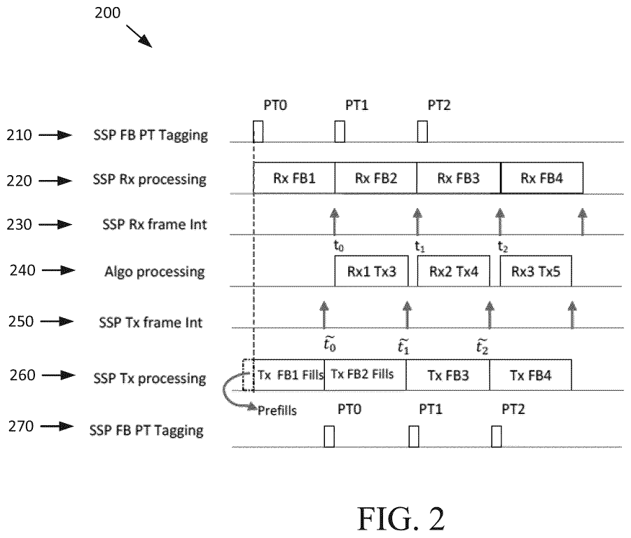

The SSP 120 may stamp the frame buffer with a presentation time counted by a global wall clock. The global wall clock time can be determined by using the rate tracking process and the timestamps generated by the audio fabric 110. The presentation time of a frame buffer is herein defined as the presentation time of the earliest sample in the frame buffer. In particular, for a frame buffer of the receive side, the presentation time of the frame buffer is the presentation time of the earliest sample that has arrived in the frame buffer. For a frame buffer of the transmit side, the presentation time of the frame is the presentation time of the earliest sample that has been consumed in the frame buffer. In some embodiments, the SSP 120 updates the presentation time for a frame just before the SSP 120 generates a frame cross interrupt. FIG. 2 shows a sequence 200 of updating presentation times for frame buffers in accordance with various implementations. Line 210 shows the presentation times for tagging frame buffers of the receive side. Line 220 shows the frame buffers of the receive side for processing. Line 230 shows the sequence of updating the presentation time for frame buffers of the receive side at the frame boundary cross time. The presentation time PTO for a frame buffer (Rx FB1) of the receive side is updated at the instant t₀ of a receive frame interrupt. The presentation time PT1 for a following frame buffer (Rx FB2) of the receive side is updated at the instant t₁ of a following receive frame interrupt. Line 270 shows the presentation times for tagging frame buffers of the transmit side. Line 260 shows the frame buffers of the transmit side for processing. Line 250 shows the sequence of updating the presentation time for frame buffers of the transmit side at the frame boundary cross time. The presentation time PTO for a frame buffer (Tx FB1 Fills) of the transmit side is updated at the instant [symbol] of a transmit frame interrupt. The presentation time PT1 for a following frame buffer (Tx FB2 Fills) of the transmit side is updated at the instant [symbol] of a following transmit frame interrupt. Line 240 shows that at the time t₀, the first frame is processed. The received Rx FB1 data is consumed and the Tx FB3 data for transmitting is generated for the next frame processing. Because the time t₁ is not aligned with the time [symbol] , the processing time for handling the Rx FB1 data and Tx FB3 data is limited. In some embodiments, all frame buffers have the same algorithm processing sample rate.

In some embodiments, the SSP 120 starts to tag the frame buffer when the rate tracking runs for the first time, which might not coincide with the presentation time of the first sample in the frame buffer. Thus, the SSP 120 may calculate the presentation time of the first sample in the frame buffer (i.e., the presentation time of the frame buffer) for tagging the frame buffer. In some embodiments, the SSP 120 uses the following formula:

$$PT = {PT}_{r } - x * \frac{{f}_{PT}}{{f}_{int}} .$$

In the above equation, PT is the presentation time for tagging the frame buffer, PTᵣ is the presentation time when the rate tracking runs for the first time. f_{PT} is the presentation time clock rate in Hz (e.g., 24.576 MHz), representing the number of presentation clock ticks in a second. fᵢₙₜ is the sample rate in Hz (e.g., 8 KHz, 16 KHz, 24 KHz, 48 KHz, 96 KHz, and 192 KHz).

$$\frac{{f}_{PT}}{{f}_{int}}$$

is a constant representing the number of presentation clocks between two consecutive samples. x is the buffer position at the time when the rate track runs for the first time, indicating the number of samples within the frame buffer. For a frame on the receive side, the number of samples are the number of samples that have been received. For a frame on the transmit side, the number of samples corresponds with the number of samples already processed/consumed.

When a frame is tagged with the presentation time, the presentation time for the following frame can be calculated as:

$${PT}_{n} = {PT}_{n - 1} + \frac{{f}_{PT}}{{f}_{int}} * {N}_{FB} .$$

In the above equation, PTₙ₋₁ is the presentation time for tagging the (n−1)-th frame buffer, PTₙ is the presentation time for tagging the n-th frame buffer. N_{FB} is the frame buffer size, indicating the number of samples in a frame. Thus,

$$\frac{{f}_{PT}}{{f}_{int}} * {N}_{FB}$$

is a constant.

The approach described above for determining the presentation time of a frame buffer is for illustration purposely only. Other approaches can be used to tag the frame buffer. For example, a software flag can be set to flag the start of a frame buffer. The SSP 120 can count the number of the samples processed from the last known presentation time to the time when the software start flag is set. In this example, the presentation time of the frame buffer can be calculated as:

PT=PTᵣₗ+n*Δ.

In the above equation, PT is the presentation time for the frame buffer, and PTᵣₗ is the last known presentation time. n is the number of samples the SSP 112 processed from the last known presentation time to the time when the start flag is set to indicate the start of the frame buffer. Δ is the number of presentation clock ticks between two consecutive samples.

The presentation time of the frame buffers can be used to make a coarse adjustment as a first step in aligning streams A and B. The SSP 120 can synchronize the slave stream B to the master stream A through two processes: a coarse adjustment and a fine adjustment. In the coarse adjustment, the presentation time of a frame buffer of the stream B is aligned with the presentation time of a corresponding frame buffer of the stream A. Then in the fine adjustment, the stream B is resampled so that every new sample of the stream B is aligned with a corresponding sample in the stream A. For the ease of illustration, it is assumed herein that the frame buffer size is the same for both streams A and B. In response to receiving a synchronization command from, for example, an application, the SSP 120 first performs the coarse adjustment to adjust the presentation time and the buffer position of the stream B to align both with those of the stream A. The buffer position refers to the position of a pointer that indicates the number of samples the frame buffer has been filled (for a frame buffer of the receive side) or consumed (for a frame buffer of the transmit side) at the time when the SSP 120 receives the synchronization command. The SSP 120 can use the following formula to adjust the frame buffer of the stream B:

$$adj = round ( \frac{{PT}_{A} - {PT}_{B\_old}}{Δ} ) , \\ {PT}_{B\_new} = {PT}_{B\_old} + adj * Δ , \\ {POS}_{B\_new} = ( {POS}_{B\_old} - adj ) mod {N}_{FB} .$$

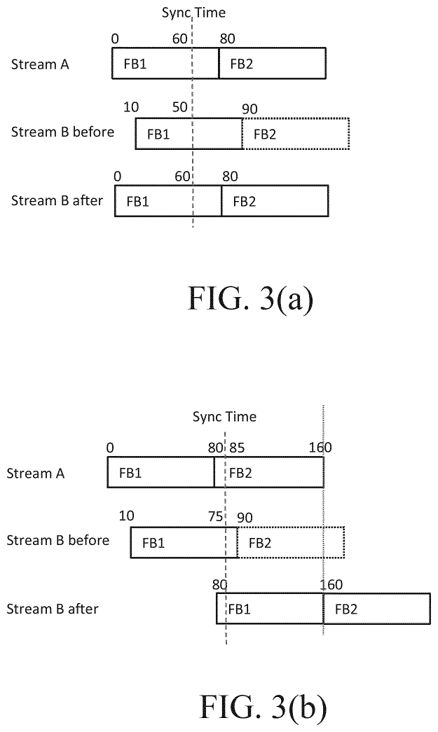

In the above equations, PT_{A} is the presentation time tagged to the frame buffer of the stream A, and PT_{B_old} is the presentation time tagged to the frame buffer of the stream B before the coarse adjustment. Δ is the number of presentation clock ticks between two consecutive samples of stream B. adj is the number of frame buffer positions to be adjusted. PT_{B_new} is the presentation time tagged to the frame buffer of the stream B after the coarse adjustment. POS_{B_old} is the buffer position of the stream B at the time when the synchronization command is received, and POS_{B_new} is the buffer position of the stream B after the coarse adjustment. N_{FB} is the frame buffer size for the stream B. If adj>0, the buffer position is adjusted backwards; if adj<0, the buffer position is adjusted forwards. FIG. 3(a) shows an example alignment of two frame buffers of different audio streams. For the ease of illustration, it is assumed that Δ=1, and N_{FB}=80. In the example of FIG. 3(a), at the time when the synchronization command is received, PT_{A}=0, PT_{B_old}=10, POS_{A}=60, POS_{B_old}=50. Thus,

$$adj = \frac{{PT}_{A} - {PT}_{B\_old}}{Δ } = - 10 , {PT}_{B\_new} = {PT}_{B\_old} + adj * Δ = 0 , \\ {POS}_{B\_new} = ( {POS}_{B\_old} - adj ) mod {N}_{FB} = 60.$$

FIG. 3(b) shows another example alignment of two frame buffers where the adjustment crosses the frame boundary. In the example of FIG. 3(b), at the time when the synchronization command is received, PT_{A}=80, PT_{B_old}=10, POS_{A}=5, POS_{B_old}=75. Thus,

$$adj = \frac{{PT}_{A} - {PT}_{B\_old}}{Δ} = 70 , {PT}_{B\_new} = {PT}_{B\_old} + adj * Δ = 80 , \\ {POS}_{B\_new} = ( {POS}_{B\_old} - adj ) mod {N}_{FB} = 5.$$

It shall be noted that streams A and B can have different sample rate as long as the two streams have the same temporal length of frame buffer. For example, if the stream A has a sample rate of 8 KHz, the stream B has a sample rate of 16 KHz, and both streams A and B have a temporal frame buffer length of 10 ms, the above formula for adjusting the presentation time and the buffer position of the stream B are still effective.

In the two examples shown in FIGS. 3(a) and 3(b), the two streams A and B are perfectly aligned because

$$\frac{{PT}_{A} - {PT}_{B\_old}}{Δ}$$

is an integer. In situations wherein

$$\frac{{PT}_{A} - {PT}_{B\_old}}{Δ}$$

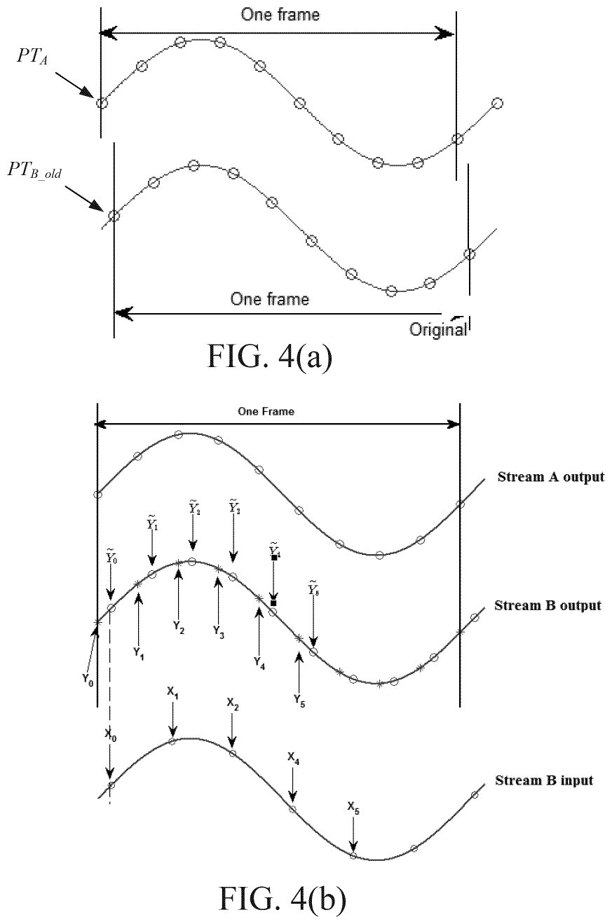

is not an integer, there could be a margin of +/− one sample error. The SSP 120 may perform a fine adjustment to further align the two streams A and B sample-by-sample. FIG. 4(a) shows two frames of streams A and B before the fine adjustment. The presentation time PT_{A} of the first sample of the frame buffer of the stream A and the presentation time PT_{B_new} of the first sample of the frame buffer of the stream B are substantially aligned with an error smaller than one Δ. FIG. 4(b) shows the frames of the stream B with respect to a frame of the stream A before and after the fine adjustment. The stream B is resampled so that each resampling point is aligned with a corresponding sampling point in the stream A. The fine adjustment is performed by the ASRC 121 and a resampler 122 on the SSP 120.

Referring to FIG. 4(b), X₀, X₁, X₂, X₃ represent sampling points of the inputting stream B from the audio fabric 110. In other words, Xₙ represents the n-th sampling point on the inputting stream B. \tilde{Y}₀, \tilde{Y}₁, \tilde{Y}₂, \tilde{Y}₃ represent sampling points of the outputting stream B before the fine synchronization. Y₀, Y₁, Y₂, Y₃ represent sampling points of the stream B after the fine synchronization. In other words, [symbol] represents the m-th sampling point of the old outputting stream B before fine adjustment and Yₘ represents the m-th sampling point of the new outputting stream B after fine adjustment. The temporal position of a sampling point is referred to as the “phase accumulator” of the sample. The phase accumulator for Yₘ is represented by PAₘ. The phase accumulator for [symbol] is represented by [symbol] . In some embodiments, the value of PAₘ and [symbol] are calculated using the following formula:

$$= 0$$

$$= + {R}_{m} , \\ = 0 + {\sum }_{j = 1}^{m} {R}_{j} . \\ {PA}_{0} = + frac ( \frac{{PT}_{A} - {PT}_{B\_old}}{Δ} ) * {R}_{0} , \\ {PA}_{m} = {PA}_{m - 1} + {R}_{m} = frac ( \frac{{PT}_{A} - {PT}_{B\_old}}{Δ} ) * {R}_{0} + {\sum }_{j = 1}^{m} {R}_{j} .$$

In the above equations, frac((PT_{B_old}−PT_{A})/Δ) is the fractional part of (PT_{B_old}−PT_{A})/Δ, as opposing to the integer part. Rₘ is the conversion ratio for the m-th resampling point. The conversion ratio R can be defined as the ratio of input sample rate of stream B to the output sample rate of stream B, which has the same sample rate as the output stream A, or it is the frame buffer sample rate in the receiving stream. Thus, R can be viewed as the output sample period measurement in terms of the input period. Therefore, R is also referred to as a “phase increment.” The phase accumulator PAₘ accumulates the instantaneous values of R until the m-th resampling point, thus representing the location of the resampling point measured in the input sample periods. In particular, if PAₘ is an integer, the resampling point Yₘ coincides with some sampling point Xₙ. If PAₘ has a fraction part, the resampling point Yₘ lies between two sampling points Xₙ and Xₙ₊₁. The integer part of PAₘ represents the index of the sampling point Xₙ, and the fraction part represents the position on the distance from Xₙ to Xₙ₊₁. For example, if Rₘ is 1.5 for all values of m and the initial phase PA₀ is 0, the value of the next phase accumulator PA₁ would be 1.5, which corresponds to a resampling point Y₁ half way between X₁ and X₂. The value of the next phase accumulator PA₁ would be 3.0, which correspond to a resampling point Y₂ coinciding with X₃, and so forth. PA₀ is

$$frac ( \frac{{PT}_{A} - {PT}_{B \_ old}}{Δ} ) * {R}_{0}$$

more than [symbol] and is aligned with the presentation time of the frame buffer of the stream A. The following output samples of stream B are aligned with corresponding sample of the stream A, thus stream B is synchronized to the stream A sample-by-sample.

Referring back to FIG. 1, the ASRC 121 calculates the conversion ratio (R) 123, and the resampler 122 updates the phase accumulator (PA) 124 with the conversion ratio 123. As discussed above, the conversion ratio R is defined as the ratio of the input sample rate of the stream B to the output sample rate of the stream B, which is the same as the sample rate of the stream A. A value of R=1 corresponds to the situation where the input sampling rate of the stream B is the same as output sample rate of stream B. A value of R<1 corresponds to the situation where the sample rate of the output stream B is higher than the original input sample rate of the stream B. A value of R>1 corresponds to the situation where the sample rate of the output stream B is lower than the original input sample rate of the stream B. In some embodiments, the ASRC 121 utilizes the timestamps associated with the samples of streams B to calculate the conversion ratio. Since the timestamps for the sample are each created by the same global counter, the timestamps are in the same clock domain and can be used to determine the sample rate for each stream. For example, the global high speed counter runs at a frequency of 240 MHz, and samples of the stream arrive at an interval of 5,000 counts according to the timestamps. The sample rate of this stream is:

$$\frac{240 MHz}{5 \text{,} 000} = 48 KHz .$$

Accordingly, the conversion ratio is calculated as follows:

$$R = \frac{Δ {T}_{B ( output )}}{Δ {T}_{B ( input )}} = \frac{Δ {T}_{A ( output )}}{Δ {T}_{B ( input )}} .$$

In the above equation, ΔT_{A(output)} is the difference in timestamp values of two consecutive samples of the output stream A, which is equivalent to the time difference of two consecutive samples of the output stream B (ΔT_{B(output)}) or equivalent to the time difference of two consecutive frame buffer samples. ΔT_{B(input)} is the difference in timestamp values of two consecutive samples of the input stream B.

The conversion ratio calculated by the above equation may include some error, at least due to the limited precision of the division algorithm. In some embodiments, the ASRC 121 may correct the conversion ratio to produce a corrected conversion ratio using a feedback mechanism. In particular, the uncorrected conversion ratio is multiplied with the time increment value between two consecutive samples of the stream B to produce an uncorrected time increment value. The uncorrected time increment value is subtracted from the time increment value between two consecutive samples of the stream B to produce an error correction value. The error correction value is applied to the uncorrected conversion ratio to produce a corrected conversion ratio. The details of the process for correcting the conversion ratio are disclosed in the U.S. Pat. No. 8,405,532, which is incorporated herein in entirety by reference.

In some embodiments, the input sample rates of the stream A and/or the stream B may vary over time. The ASRC 121 can perform sample ratio conversion for arbitrary conversion ratios, which can vary over time from sample to sample. This can be used in applications where the conversion ratio is not known at the time of ASRC design, but rather is calculated by timestamp measurements on incoming streams.

In other embodiments, the ASRC 121 can be implemented differently, which does not use the timestamps to calculate the conversion ratio. For example, if the conversion ratio between streams A and B is known at the time of ASRC design, which can be expressed as a ratio of two integers and does not change over time, the ASRC 121 may utilize polyphase filters for generating the conversion ratio. The ASRC based on polyphase filters have the advantages for implementation in hardware and in vector signal processors. It shall be noted that other approaches for implementing the ASRC can also be used.

The resampler 122 receives the sample data of the stream B, receives the conversion ratio 123 from the ASRC 121, and updates the phase accumulator (PA) 124 with the conversion ratio R. As discussed above, the PA 124 starts from

$${PA}_{0} = frac ( \frac{{PT}_{{B}_{old}} - {PT}_{A}}{Δ} ) * {R}_{0} ,$$

and accumulates the increments R to determine the resampling points for the stream B. In some embodiments, R is computed from real-time measurements of sample periods which might suffer quantization errors resulting from finite arithmetic precision and possibly other error sources. As the phase accumulator PA accumulates the R values, the finite precision errors may accumulate. The resampler 122 may use a feedback mechanism to correct the PA 124. In particular, a calculated latency for a resampling point is compared to a measured latency for the resampling point. A latency error 125 is generated to indicate the difference. Then the SSP 120 utilizes the latency error 125 as a feedback to correct successive values of conversion ratio R for successive PA calculation.

The calculated latency for the resampling point Yₘ is a latency corresponding to the phase accumulator PAₘ. The measured latency is the presentation time of the resampling point Yₘ, which can be measured by the audio fabric 110 on a real-time basis. In some embodiments, the time measured by the audio fabric 110 is in units of “wall clock period” of the global counter. The phase accumulator PAₘ is the index of the resampling point Yₘ in the input sample periods. The phase accumulator may be converted to the same clock domain as the measured time for the purpose of comparison. The sample rate is based on an internal time base, for example, using a chip's crystal oscillator and a processor clock. The “wall clock” can count these clock cycles. k is defined as the number of “wall clock” counts between two consecutive output samples Yₘ₋₁ and Yₘ. For a stream from the receive side, the latency error 125 can be calculated as follows:

ERRₘ=(PTₙ−PT₀)−k*m+(PAₘ−n)/Rₘ.

In the above equation, ERRₘ is the latency error for the m-th resampling point Yₘ. n is the integer part of PAₘ. PT₀ is the presentation time for the sample Y₀, and PTₙ is the presentation time for the sample Xₙ. While PAₘ starts to accumulate from

$${PA}_{0} = frac ( \frac{{PT}_{A} - {PT}_{B \_ old}}{Δ} ) * {R}_{0} ,$$

the starting point would not cause a mistake in calculating ERRₘ because the presentation time PT₀ of the earliest sample Y₀ has been offset by

$$frac ( \frac{{PT}_{A} - {PT}_{B \_ old}}{Δ} )$$

accordingly. This rebalances the rate tracking.

For a stream on the transmit side, the operation of the phase accumulation and rate tracking are different. For a transmitting stream, the PAₘ for any output sample Yₘ represents the location of the m-th sample on the continuous stream formed by frame buffer samples Xₙ. The integer part of PAₘ represents n, the index of the input sample Xₙ at or prior to the output Yₘ, and the fractional part of PAₘ represents the fraction of the way between Xₙ and Xₙ+1 that Yₘ lies. PAₘ is decreased by

$$frac ( \frac{{PT}_{A} - {PT}_{B \_ old}}{Δ} ) .$$

The latency error can be calculated as follows:

ERR=(PTₘ−PT₀)−k*PAₘ.

In the above equation, PTₘ is the presentation time for transmitting output stream sample Yₘ, PT₀ is the presentation time for output sample Y₀ (and frame buffer sample X₀), k is the Wall Clock ticks per frame buffer sample period, which is the same as the value of Δ, and PAₘ is the phase accumulator for sample Yₘ. Thus, the latency error is:

ΔERR=−frac(PT_{A}−PT_{B}_{_{old}}).

It can be seen that adjusting the PT₀ accordingly with frac(PT_{A}−PT_{B}_{_{old}}) keeps the rate tracking in balance.

The latency error (ERRₘ) 125 represents a mismatch between the time for outputting the sample Yₘ according to the phase accumulator calculated by the resampler 122 and the measured outputting time of Yₘ by the audio fabric 110. If the measured latency is the same as the corresponding calculated latency, the ASRC 121 and the resampler 122 are operating at the proper latency so that the sample rate conversion ratio R is correct and no buffer slip occurs. If any difference exists, the resampler 122 can use the latency error to correct the conversion ratio in order to reduce or minimize the difference. Further details of the process for rate tracking are disclosed in the U.S. Pat. No. 8,965,942, which is incorporated herein in entirety by reference.

In the process of rate tracking as discussed above, a latency error ERRₘ is derived for every sample Yₘ, and a corrected value of Rₘ is generated for every Yₘ. In alternative embodiments, the latency error ERRₘ can be computed just for the first sample in a frame buffer of the audio stream. A corrected value of Rₘ is generated from ERRₘ, which is to be used for all successive sample ratio conversion until the next frame buffer starts.

The resampler 122 then calculates the sample data for each resampling point Yₘ. In some implementations, the inputting sample data at the sampling point Xₙ, which is at or just prior to the resampling point Yₘ, is duplicated to create the outputting sample data to represent the digital audio waveform. In other implementations, the outputting sample data may be an interpolation value based on the input sample data at the sample points Xₙ and Xₙ₊₁ between which the resampling point Yₘ lies. It shall be noted that the examples given herein are for illustration and not for limitation. Other approaches can be employed to generate the sample data for the resampling point Yₘ.

As can be seen from the discussion above, the master stream can be either a receiving stream or a transmitting stream. As long as the presentation time of the frame buffer of the master stream is properly tagged, the slave receiving stream can be synchronized to the master stream. In scenarios of synchronizing two transmitting streams or synchronizing one transmitting and one receiving stream, as long as the slave transmitting stream can be synchronized to the master stream, stream synchronization can be achieved. Synchronization for slave transmitting stream can be done in the similar way as the synchronization for a slave receiving stream. The input of the slave transmitting stream fills a frame buffer. The tagged presentation time of slave transmitting stream is the time when the earliest sample is being consumed by the audio fabric 110. The time can be derived using the rate tracking process, triggered by an event of the audio fabric transmitting one sample to the audio port. The SSP 120 computes the phase difference the same way as the receiving stream. First, a coarse adjustment is done as follows:

$$adj = round ( \frac{{PT}_{A} - {PT}_{B \_ old}}{Δ} ) , \\ {PT}_{B \_ new} = {PT}_{B \_ old} + adj * Δ , \\ {POS}_{B \_ new} = ( {POS}_{B \_ old} - adj ) mod {N}_{FB} .$$

The fine adjustment is similar to the receiving stream case.

$$frac ( \frac{{PT}_{A} - {PT}_{B \_ old}}{Δ} )$$

is added to the phase accumulator of the slave ASRC. The error computation is different for rate tracking as discussed above.

In some embodiments, the system 100 can be used to control the relative offset of the streams A and B. For example, the system 100 is implemented on an electronic device that has a user interface. A user can request, though the interface, that the stream B is offset a certain time (e.g., 1 milliseconds later, 1 milliseconds earlier, 5 milliseconds later, 5 millisecond earlier, 60 milliseconds later, 60 milliseconds earlier, etc.) relative to the stream A. In response to receiving the request, the system 100 determines the current temporal difference between the two streams, compares the current temporal difference to the user requested difference to generate a gap, converts the gap to a phase difference, and adjusts the phase accumulator based on the phase difference. Assume, for example, that a receiving stream Rx is the master stream and a transmitting stream Tx is the slave stream. In response to a user-requested offset, a coarse adjustment is performed on the stream Tx as follows:

$$adj = round ( \frac{{PT}_{Rx} - {PT}_{Tx \_ old} + {PT}_{adj}}{Δ} ) , \\ {PT}_{Tx \_ new} = {PT}_{Tx \_ old} + adj * Δ , \\ {POS}_{Tx \_ new} = ( {POS}_{Tx \_ old} - adj ) mod {N}_{FB} .$$

In the above equations, PT_{Rx} is the presentation time tagged to the frame of the stream Rx, and PT_{Tx_old} is the presentation time tagged to the frame of the stream Tx before the coarse adjustment. PT_{adj} is the user requested offset in the unit of the “wall clock periods” used to tag the presentation times. Δ is the number of presentation clock ticks between two consecutive samples of stream Tx. adj is the number of frame buffer positions to be adjusted. PT_{Tx_new} is the presentation time tagged to the frame of the stream Tx after the coarse adjustment. POS_{Tx_old} is the buffer position (i.e., the number of consumed samples) of the stream Tx at the time when the alignment command is received, and POS_{Tx_new} is the buffer position (i.e., the number of consumed samples) of the stream Tx after the coarse adjustment. N_{FB} is the frame buffer size for the stream Tx. If adj>0, the buffer position is adjusted backwards; if adj<0, the buffer position is adjusted forwards. If the coarse adjustment crosses a frame boundary, the adjustment will be wrapped inside one frame buffer.

After the coarse adjustment, the SSP can perform the fine adjustment on the stream Tx as described above, that is, resample the stream Tx so that each new sample in the stream Tx is aligned to a corresponding sample in the stream Rx by adding the

$$frac ( \frac{{PT}_{Rx} - {PT}_{Tx \_ old} + {PT}_{adj}}{Δ} )$$

to the phase accumulator. Since the user requested offset has been considered in determining the presentation time of the new frame buffer and the buffer position for the stream Tx through the parameter adj, the fine adjustment can be performed in the same manner as the process discussed above in reference to the embodiments of synchronization of two streams.

The synchronization can be achieved at any time besides at the beginning of the startup stage. As long as the presentation times have been tagged to the frame buffers during the normal system operation, the SSP 120 can start synchronizing a slave stream to a master stream in response to a request by a user to synchronize the two streams. First, the SSP 120 computes the presentation time difference as illustrated previously and convert the difference into an integer part of the phase difference, which is used for adjusting the frame buffer pointer (coarse adjustment), and a fractional part, which is added into phase accumulator in Rate Tracker. Due to the sudden change of the phase, the corresponding error computing in Rate Tracker will be adjusted accordingly to keep the error in balance. The resampler conducts the fine adjustment on the output sample time, which is align with the master stream automatically. The resampler data will be generated accordingly. An audio click is desired due to the signal discontinuity during synchronization stage.

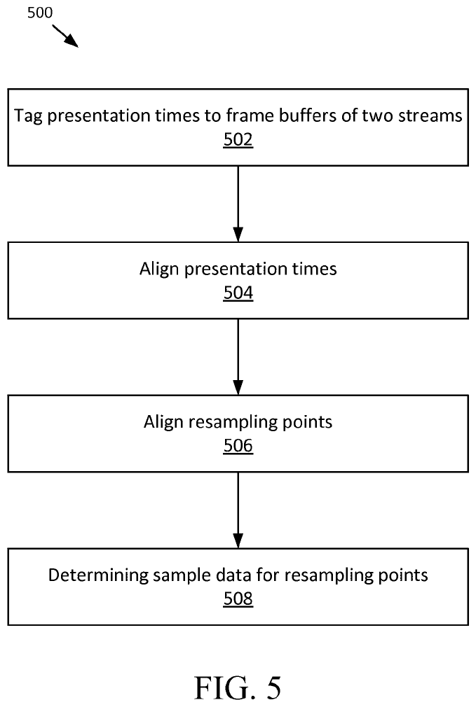

Referring now FIG. 5, a process 500 for synchronizing audio streams is shown in accordance various implementations. The process 500 may be performed by the system 100 of FIG. 1.

At step 502, a first presentation time is tagged to a frame buffer of a first audio stream, and a second presentation time is tagged to a frame buffer of a second audio stream. The second audio stream is to be synchronized to the first audio stream. The first and second audio streams may arrive at an audio fabric through different paths from different audio sources, for example, from two digital signal processors (DSP). In some embodiments, the first audio stream is generated by a smart microphone and the second audio stream is received from another microphone external to the smart microphone. The first and second streams each consist of a plurality of ordered samples and may have different sample rates in different clock domains. The audio fabric can create timestamps to label the time when individual samples of the first and second streams arrive at the audio fabric. The timestamps can be created at a lower rate than the sample rate. For example, timestamps can be created every four samples, every eight samples, every sixteen samples, and so on. A global high-speed counter (e.g., a “wall clock”) can be used to create the timestamps to label the individual samples.

The first and second audio streams are processed based on frames. A frame is a set of samples that are processed as a unit. The presentation time of a buffer for buffering the frame (i.e., the frame buffer) is defined as the presentation time of the first (i.e., the earliest) sample in the frame buffer. In particular, for a frame from the receive side, the presentation time of the frame is the presentation time of the first sample that has arrived in the frame buffer. For a frame from the transmit side, the presentation time of the frame is the presentation time of the first (i.e., the earliest) sample that has been consumed in the frame buffer. The presentation time for the frame buffer can be determined in various ways. In some embodiments, the presentation time is determined as:

$$PT = {PT}_{r} - x * \frac{{f}_{PT}}{{f}_{int}} .$$

In the above equation, PT is the presentation time for the frame buffer, PTᵣ is the presentation time when the rate track runs for the first time. f_{PT} is the presentation time clock in Hz (e.g., 24.576 MHz), representing the number of presentation clocks in a second. fᵢₙₜ is the sample rate in Hz (e.g., 8 KHz, 16 KHz, 24 KHz, 48 KHz, 96 KHz, and 192 KHz).

$$\frac{{f}_{PT}}{{f}_{int}}$$

is a constant representing the number of presentation clocks between two consecutive samples. x is the buffer position at the time when the rate track runs for the first time, indicating the number of samples within the frame buffer. For a frame on the receive side, the number of samples are the number of samples that have been received. For a frame on the transmit side, the number of samples corresponds with the number of samples already processed/consumed. In some embodiments, the presentation time is determined as:

$${PT}_{n} = {PT}_{n - 1} + \frac{{f}_{PT}}{{f}_{int}} * {N}_{FB} .$$

In the above equation, PTₙ₋₁ is the presentation time for tagging the (n−1)-th frame, PTₙ is the presentation time for tagging the n-th frame. N_{FB} is the frame buffer size, indicating the number of samples in a frame. Thus,

$$\frac{{f}_{PT}}{{f}_{int}} * {N}_{FB}$$

is a constant. In some embodiments, the presentation time is determined as:

PT=PTᵣₗ+n*Δ.

In the above equation, PT is the presentation time for the frame buffer, and PTᵣₗ is the last presentation time. n is the number of samples that have been processed from the last presentation time to the time when the frame buffer starts. A is the number of presentation clock ticks between two consecutive samples.

At step 504, the second presentation time of the frame buffer of the second stream is aligned with the first presentation time of the frame buffer of the first stream. This process is referred to as a “coarse adjustment” herein. In some embodiments, the difference between the first and second presentation times is determined. Then the integer part of the difference in the unit of the “sample period” of the second audio stream is calculated. The presentation time of the first sample of the second stream is slid for an amount of the integer part of the difference. If the difference between the first and second presentation times in the unit of the sample period is an integer, then the first and second presentation times can be aligned perfectly. If the difference has a fraction part, then the first and second presentation times can be aligned with a margin of +/− one sample error.

At step 506, the second audio stream is resampled so that each new sampling point of the second stream is aligned with a corresponding sampling point in the first audio stream. Thus, when combined, the two audio streams can be considered as a single stream for the purpose of signal processing because the two audio streams are aligned sample-by-sample. In some embodiments, a conversion ratio R is determined, which is defined as the ratio of the sample rate of the second audio stream to the sample rate of the first audio stream. In some embodiments, the conversion ratio R is calculated as the ratio of the difference in timestamp values of two consecutive samples of the first audio stream to the difference in timestamp values of two consecutive samples of the second audio stream. In other embodiments, the conversion ratio R is determined using polyphase filter(s). The conversion ratio R may change over time. A set of phase accumulators are determined, each corresponding to a resampling point in the unit of the sample period of the second audio stream. The set of phase accumulators starts at a phase that is the fraction part of the difference between the first and second presentation times in the unit of the sample period. The following phase accumulators each accumulate the conversion ratio R until the corresponding resampling point.

In further embodiments, a latency error is determined which can be used to correct the conversion ratio R. The latency error is defined as the difference between a calculated latency corresponding to the phase accumulator and a measured latency (e.g., measured presentation time) by the audio fabric on a real-time basis. In some embodiments, a latency error is determined for every resampling point, and a corrected value of conversion ratio is generated for each. In other embodiments, the latency error is determined just for the first sample in a frame buffer of the audio stream. A corrected value of conversion ratio is generated from the latency error and used for all successive sample ratio conversion until the next frame buffer starts.

At step 508, sample data is determined for each resampling point of the second audio stream. In some implementations, the inputting sample data at the sampling point, which is at or just prior to the resampling point, is duplicated to create the outputting sample value to represent the second audio stream. In other implementations, the outputting sample value is an interpolation value based on the inputting sample data at the sample points between which the resampling point lies. Other approaches can be employed to generate the resample data at the resampling points.

With the fine adjustment in which the samples are adjusted inside a frame buffer, the milli-sample accuracy of synchronization can be achieved. With the sample-by-sample alignment, the resulting streams can be considered as a single stream for the purpose of signal processing—there will be no variation in synchronism based on starting conditions. This allows, for example, combining digital and analog microphones to form a single microphone meta-stream. For instance, a cell phone includes a digital microphone and an analog microphone. A phase difference may exist between the digital and analog microphones due to the nature of different hardware implementation. The signal from the digital microphone is delayed in phase with respect to the signal from the analog microphone. Noise suppression or echo cancellation algorithm might be sensitive to the phase difference between two inputs from the digital and analog microphones. By synchronizing the digital microphone with analog microphone and compensating the phase difference, the noise suppression algorithm can perform better. Thus, the streams can be synchronized and the latency accuracy can be improved without sacrificing the deadline margin.

Furthermore, the variation in the maturation timing for the receive-side frame buffers and the deadline of transmit-side frame buffers can be minimized. The frame buffers of the receive side and the transmit side can have identical presentation times when synchronized per the disclosure herein. In particular, the receive-side frame buffer matures when the SSP is processing the second to the last samples in the frame buffer. That sample's arrival time is from zero to one input period prior to the presentation time of the last sample in the frame buffer. The SSP scheduling allows for up to two receive-side input periods of jitter in the actual processing time. These two variations are additive; thus the time at which the frame buffer matures is somewhere between one sample period before the presentation time of the last sample in the frame buffer and two sample periods after the presentation time of the last sample in the frame buffer.

For two synchronized frame buffers with identical presentation times, the constraint holds for both, and the variation in maturity is within the same window of three sample periods. The variation is independent of the frame buffer period. For frame buffers synchronized only at the level of coarse adjustment, the variation in maturity time is increased to three sample periods plus one frame buffer sample period. For example, if the receive-side sample rate is 48 KHz and the frame buffer sample rate is 8 KHz, the variation can decreases from 188 μsec to 63 μsec under the sub-sample synchronization as disclosed here.

The method can be applied to controlling the relative of two streams, for example, a transmitting stream and a receiving stream. Since the presentation times determine the buffering latency of the path, accurate control over the presentation times can support the tight control of latency. That is, controlling the presentation times with sub-sample period accuracy can eliminate variations of latency of different starting conditions. As shown, the presentation of a transmitting and a receiving frame buffer can be shifted by an arbitrary amount. Thus the buffering latency can be minimized with the implementation of the method disclosed herein.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method for synchronizing audio streams, the method comprising:
tagging, by a processor, a first presentation time to a frame buffer of a first audio stream and a second presentation time to a frame buffer of a second audio stream, wherein the second audio stream is to be synchronized to the first audio stream;
aligning, by the processor, the second presentation time of the frame buffer of the second audio stream with the first presentation time of the frame buffer of the first audio stream;
resampling, by the processor, the second audio stream so that each resampling point of the second stream is aligned with a corresponding sampling point in the first audio stream; and
determining, by the processor, sample data for each resampling point of the second audio stream.

2. The method of claim 1, wherein tagging the first presentation time to the frame buffer of the first audio stream comprises tagging a presentation time of the earliest sample in the frame buffer as the first presentation time, and wherein tagging the second presentation time to the frame buffer of the second audio stream comprises tagging a presentation time of the earliest sample in the frame buffer as the second presentation time.

3. The method of claim 1, wherein aligning the second presentation time with the first presentation time comprises:
determining a presentation time difference between the first presentation time and the second presentation time;
determining an integer part of the presentation time difference in a unit of a sample period of the second audio stream; and
sliding the second presentation time for the integer part of the presentation time difference.

4. The method of claim 3, wherein resampling the second audio stream comprises:
determining a conversion ratio which is a ratio of a sample rate of the second audio stream to a sample rate of the first audio stream; and
determining a set of phase accumulators, each corresponding to a location of a resampling point on the second audio stream,
wherein the set of phase accumulators starts at a fractional part of the presentation time difference between the first presentation time and the second presentation time, and wherein each following phase accumulator accumulates the conversion ratio until the corresponding resampling point.

5. The method of claim 4, wherein determining the conversion ratio includes dividing a first difference in timestamp values of two consecutive samples of the first audio stream by a second difference in timestamp values of two consecutive samples of the second audio stream.

6. The method of claim 4, further comprising:
determining, by the processor, a latency error, which is a difference between a calculated latency corresponding to the phase accumulator and a measured latency by an audio fabric on a real-time basis, wherein the first audio stream and the second audio stream are transported by the audio fabric; and
applying, by the processor, the latency error to correct the conversion ratio.

7. The method of claim 1, wherein determining sample data comprises interpolating sample data based on samples of the second audio stream.

8. The method of claim 1, wherein aligning the second presentation time with the first presentation time includes adding a specified temporal offset.

9. An apparatus for synchronizing audio streams, the apparatus comprises:
an audio fabric structured to transport a first audio stream and a second audio stream; and
a single sample processor (SSP) communicably connected to the audio fabric, the SSP structured to:
tag a first presentation time to a frame buffer of the first audio stream and a second presentation time to a frame buffer of the second audio stream, wherein the second audio stream is to be synchronized to the first audio stream;
align the second presentation time of the frame buffer of the second audio stream with the first presentation time of the frame buffer of the first audio stream;
resample the second audio stream so that each resampling point of the second audio stream is aligned with a corresponding sampling point in the first audio stream; and
determine sample data for each resampling point of the second audio stream.

10. The apparatus of claim 9, wherein the SSP is further structured to tag a presentation time of the earliest sample in the frame buffer of the first audio stream as the first presentation time, and tag a presentation time of the earliest sample in the frame buffer of the second audio stream as the second presentation time.

11. The apparatus of claim 9, wherein the SSP is further structured to:
determine a presentation time difference between the first presentation time and the second presentation time;
determine an integer part of the presentation time difference in a unit of a sample period of the second audio stream; and
slide the second presentation time for the integer part of the presentation time difference.

12. The apparatus of claim 11, the SSP is further structured to:
determine a conversion ratio which is a ratio of a sample rate of the second audio stream to a sample rate of the first audio stream; and
determine a set of phase accumulators, each corresponding to a location of a resampling point on the second audio stream,
wherein the set of phase accumulators starts at a fractional part of the presentation time difference between the first presentation time and the second presentation time, and wherein each following phase accumulator accumulates the conversion ratio until the corresponding resampling point.

13. The apparatus of claim 12, wherein the SSP is further structure to divide a first difference in timestamp values of two consecutive samples of the first audio stream by a second difference in timestamp values of two consecutive samples of the second audio stream.

14. The apparatus of claim 12, wherein the SSP is further structured to:
determine a latency error, which is a difference between a calculated latency corresponding to the phase accumulator and a measured latency by the audio fabric on a real-time basis; and
apply the latency error to correct the conversion ratio.

15. The apparatus of claim 9, wherein the SSP is further structured to interpolate sample data based on samples of the second audio stream.

16. The apparatus of claim 9, wherein the SSP is further structured to align the second presentation time with the first presentation time with a specified temporal offset.

17. A smart microphone comprising:
a processor for synchronizing a first audio stream generated by the smart microphone and a second audio stream received from a second microphone, the processor is structured to:
tag a first presentation time to a frame buffer of the first audio stream and a second presentation time to a frame buffer of the second audio stream, wherein the second audio stream is to be synchronized to the first audio stream;
align the second presentation time of the frame buffer of the second audio stream with the first presentation time of the frame buffer of the first audio stream;
resample the second audio stream so that each resampling point of the second audio stream is aligned with a corresponding sampling point in the first audio stream; and
determine sample data for each resampling point of the second audio stream.

18. The smart microphone of claim 17, further comprising an audio fabric structured to transport the first audio stream generated by the smart microphone and the second audio stream received from the second microphone, wherein the processor is structured to process an output of the audio fabric.

19. The smart microphone of claim 17, wherein the processor is communicably connected to an audio fabric disposed at a host device of the smart microphone, wherein the audio fabric is structured to transport the first audio stream generated by the smart microphone and the second audio stream received from the second microphone, and wherein the host device is structured to process an output of the audio fabric.

20. The smart microphone of claim 17, wherein the processor is further structured to align the second presentation time with the first presentation time with a specified temporal offset.
